(19) United States
(12) Patent Application Publication
(10) Pub. No.: US 2009/0153538 A1
(43) Pub. Date: Jun. 18, 2009

(54) LIQUID CRYSTAL DRIVING DEVICE, AND LIQUID CRYSTAL DISPLAY DEVICE USING SAME

(75) Inventors: Yoshiyuki Nakatani, Kyoto-shi (JP); Takayuki Nakashima, Kyoto-shi (JP)

Correspondence Address: FISH & RICHARDSON P.C.;Citigroup Center, 52nd floor, 153 East 53rd Street, New York, NY, 10022-4611, US

(73) Assignee: Rohm Co., Ltd., Kyoto (JP)

(21) Appl. No.: 12/256,656

(22) Filed: Oct. 23, 2008

(30) Foreign Application Priority Data
Oct. 25, 2007 (JP) 2007-277160

(51) Int. Cl. G09G 3/36; G09G 5/00

(52) U.S. Cl. 345/212; 345/94

(57) ABSTRACT

A liquid crystal driving device includes: a power supply unit for monitoring, using a first power supply voltage as a drive voltage, a second power supply voltage higher than the first power supply voltage to generate a monitor signal indicating whether or not the first power supply voltage is below a predetermined threshold; a logic unit for generating, using the first power supply voltage as a drive voltage, a reset request signal according to the monitor signal; a reset signal generation unit for generating, using a second power supply voltage as a drive voltage, a reset signal according to the reset request signal; and a driver unit for discharging, using the second power supply voltage as a drive voltage, liquid crystal cells according to the reset signal.

This application is based on Japanese Patent Application No. 2007-277160 filed on Oct. 25, 2007, the contents of which are hereby incorporated by reference.

### BACKGROUND OF THE INVENTION

1. Field of the Invention

The present invention relates to liquid crystal driving devices for controlling the driving of liquid crystal cells, and to liquid crystal display devices using such a liquid crystal driving device.

2. Description of Related Art

Recently, liquid crystal display devices have been widely in general use as means of display in personal computers, mobile phones, and the like.

As examples of the conventional art related to the liquid crystal display devices and power supply devices therefor, Japanese Unexamined Patent Publication UP-A) No. H9-160000 and No. H5-224621 can be cited.

As shown in FIG. 4, a conventional driver IC in a liquid crystal display device is fed with a first power supply voltage Vcc1 (1.8 V, for example) for driving logic circuitry (a logic unit 100) and a second power supply voltage Vcc2 (2.8 V, for example) for driving analog circuitry (such as a reset signal generation unit 200 and a driver unit 300). When the power to the liquid crystal display device is turned off, the liquid crystal cells are discharged by the driver unit 300 using a reset signal EN outputted from the reset signal generation unit 200 as a trigger. In this sequence, the operation of the liquid crystal display device can be stopped after electric charges have been discharged from the cells. Accordingly, unwanted lines are not generated on the liquid crystal display panel.

However, with a conventional driver IC, in a case where the power to the liquid crystal display device is turned off in a sequence different from the normal one, such as when a battery is removed while the display device is in operation, the second power supply voltage Vcc2 for driving the analog circuitry may fall below the minimum operation guarantee level thereof (the minimum voltage level that ensures normal operation of the analog circuitry), possibly making the reset signal generation unit 200 inoperative. When this happens, in the conventional driver IC, the driver unit 300 cannot proceed with the discharging of the liquid crystal cells, and unwanted electric charges are left in the cells even after the operation of the display device is stopped, resulting in unwanted lines to be generated on the panel.

### SUMMARY OF THE INVENTION

In light of the above problem, it is a main object of the present invention to provide liquid crystal driving devices capable of surely discharging electric charges from liquid crystal cells upon power-off, and to provide liquid crystal display devices using such a liquid crystal driving device.

In order to achieve the above object, a liquid crystal driving device of the present invention includes: a power supply monitor for monitoring, using a first power supply voltage as a drive voltage, a second power supply voltage higher than the first power supply voltage so as to generate a monitor signal that indicates whether or not the second power supply voltage is below a predetermined threshold; a logic unit for generating, using the first power supply voltage as a drive voltage, a reset request signal according to the monitor signal; a reset signal generation unit for generating, using the second power supply voltage as a drive voltage, a reset signal according to the reset request signal; and a driver unit for discharging, using the second power supply voltage as a drive voltage, liquid crystal cells according to the reset signal.

With this configuration, electric charges can be surely discharged from the liquid crystal cells upon power-off.

Other features, elements, advantages, and characteristics of the present invention will become more apparent from the following Detailed Description of Preferred Embodiments thereof with reference to the accompanying drawings.

### BRIEF DESCRIPTION OF THE DRAWINGS

FIG. 1 is a block diagram showing a liquid crystal display device in accordance with one embodiment of the present invention.

FIG. 2 is a block diagram for realizing discharging of liquid crystal cells in accordance with the one embodiment of the present invention.

FIG. 3 is a block diagram showing an example of the configuration of an analog power supply monitor 20 in accordance with the one embodiment of the present invention.

FIG. 4 is a block diagram showing an example of a conventional liquid crystal driving device.

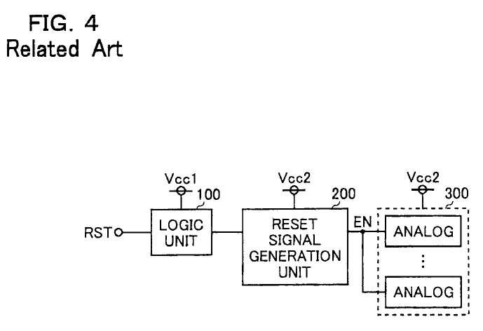

### DETAILED DESCRIPTION OF PREFERRED EMBODIMENTS

The present invention will be described hereinafter in detail by way of example where it is applied to a liquid crystal display device.

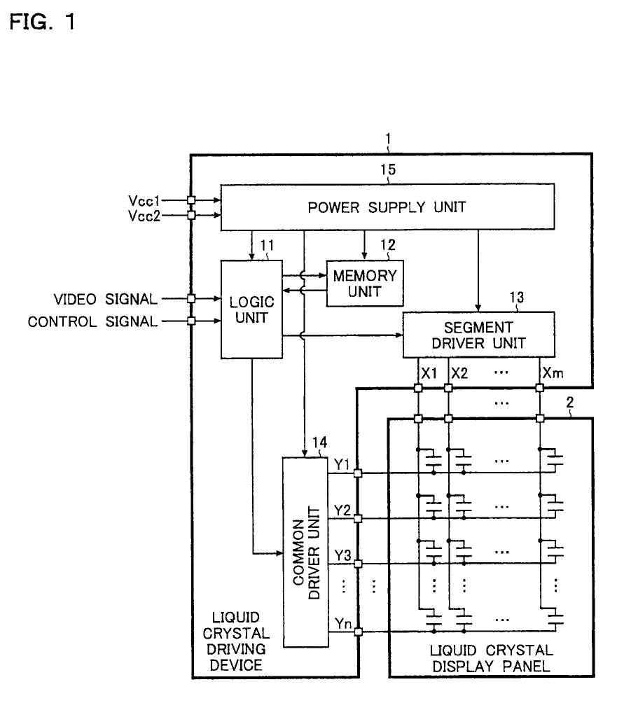

FIG. 1 is a block diagram showing a liquid crystal display device in accordance with one embodiment of the present invention.

As shown in FIG. 1, the liquid crystal display device of this embodiment includes a liquid crystal driving device 1 and a liquid crystal display panel 2 to be driven thereby.

The liquid crystal driving device 1 is a capacitance load driving device for driving liquid crystal cells of the liquid crystal display panel 2 and is a semiconductor device having a logic unit 11, a memory unit 12, a segment driver unit 13, a common driver unit 14, and a power supply unit 15 formed into an integrated circuit.

The logic unit 11 receives a video signal and a control signal and supplies the segment driver unit 13 and the common driver unit 14 with various signals (including a data signal, a common select signal, etc.) necessary for controlling the liquid crystal display; the logic unit 11 includes data registers, a command decoder, an MPU (Micro Processing Unit) interface, control registers, an address counter, and a timing generator (all not shown).

The memory unit 12 is a buffer that temporarily stores a segment control signal that is generated, read-out, and transferred by the logic unit 11 to the segment driver unit 13.

The segment driver unit 13 generates segment drive signals X1 to Xm and feeds them to their corresponding signal lines (one end of each liquid crystal cell) of the liquid crystal panel 1 according to the data signal inputted from the logic unit 11 (hence, a video signal inputted from an external device).

The common driver unit 14 generates common drive signals Y1 to Yn and feeds them to their corresponding scanning lines of the liquid crystal display panel 1 (the other end of each liquid crystal cell) according to the common select signal from the logic unit 11.

The power supply unit 15 receives from outside the device the first power supply voltage Vcc1 (mainly for driving logic circuitry, for example 1.8 V) and the second power supply voltage Vcc2 (mainly for driving analog circuitry, for example, 2.8 V) and supplies the power to each of the logic unit 11, the memory unit 12, the segment driver unit 13, and the common driver unit 14. The power supply unit 15 has smoothing capacitors connected to respective supply lines of the first power supply voltage Vcc1 and the second power supply voltage Vcc2. When the power to the liquid crystal display device is turned off, voltage levels of the first and second power supply voltages Vcc1 and Vcc2 gradually drop as the smoothing capacitors are discharged.

The liquid crystal display panel 2 is a simple matrix type (STN (Super Twisted Nematic) type) panel having a liquid crystal cell interposed at each of intersections between the signal lines (segment signal lines) and the scanning lines (common signal lines) orthogonal thereto. Here, in order to display characters or an image, by applying a voltage to each liquid crystal cell, the alignment of liquid crystal molecules is changed, and the transmission of light is controlled thereby.

Next, the discharging of the liquid crystal cells upon power-off of the liquid crystal display device will be described.

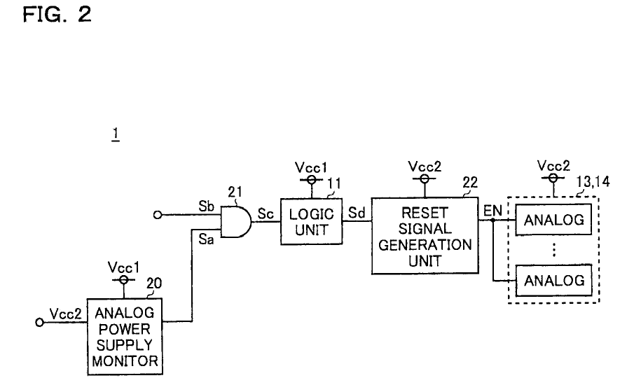

FIG. 2 is a block diagram for realizing the discharging of the liquid crystal cells.

As shown in FIG. 2, the liquid crystal driving device 1 of this embodiment includes, apart from the circuit blocks 11 to 15 shown in FIG. 1 mentioned above, an analog power supply monitor 20, an logical AND operator 21, and a reset signal generation unit 22 as circuit blocks associated with the discharging of the liquid crystal cells.

Using the first power supply voltage Vcc1 as a drive voltage, the analog power supply monitor 20 monitors the second power supply voltage Vcc2 higher than the first power supply voltage Vcc1 so as to generate a monitor signal Sa that indicates whether or not the second power supply voltage Vcc2 is below a predetermine threshold (any value greater than the minimum operation guarantee level of the analog circuitry). Note that the monitor signal Sa is a binary signal that is Low if the second power supply voltage Vcc2 is below the predetermined threshold and that is otherwise High. A detailed description on an internal configuration and an operation of the analog power supply monitor 20 will be provided further below.

The logical AND operator 21 is a logic gate unit for generating a logical AND operation signal Sc that is a product between the monitor signal Sa and an external reset signal Sb. That is, the logical AND operation signal Sc is a binary signal that is High only if both the monitor signal Sa and the external reset signal Sb are High and that is otherwise Low.

Using the first power supply voltage Vcc1 as a drive voltage, the logic unit 11 not only realizes various functions including the above but also generates a reset request signal Sd according to the logical AND operation signal Sc. Note that the logic unit 11 sends out the reset request signal Sd using a falling edge of the logical AND signal Sc as a trigger.

Using the second power supply voltage Vcc2 as a drive voltage, the reset signal generation unit 22 generates a reset signal EN according to the reset request signal Sd.

Using the second power supply voltage Vcc2 as a drive voltage, the segment driver unit 13 and the common driver unit 14 not only realize the above-described functions but also discharge the liquid crystal cells (not shown in FIG. 2) according to the reset signal EN.

In the liquid crystal driving device 1 configured as described above, the logic unit 11 sends the reset request signal Sd to the reset signal generation unit 22 not only when the external reset signal Sb becomes Low but also when the analog power supply monitor 20 detects the second power supply voltage Vcc2 falling below the predetermined threshold and the monitor signal Sa becomes Low.

Thus, in a case where the power to the liquid crystal display device is turned off in a sequence different from the normal one, such as when a battery is removed from the liquid crystal display device in operation, the reset signal generation unit 22 sends the reset signal EN to the segment driver 13 and the common driver unit 14 before the second power supply voltage Vcc2 falls below the minimum operation guarantee level of the analog circuitry, thereby allowing the liquid crystal display device to be stopped after the electric charges stored in the liquid crystal cells have been surely discharged. Unwanted lines may not be generated on the liquid crystal display panel 2, accordingly.

Although it is inevitable that the second power supply voltage Vcc2 as well as the first power supply voltage Vcc1 drops upon power-off of the liquid crystal display device, the first power supply voltage Vcc1 is unlikely to fall below the minimum operation guarantee level of the logic circuitry as long as the second power supply voltage Vcc2 is above the minimum operation guarantee level of the analog circuitry. The above-described reset operation is, therefore, carried out without fail. Moreover, even if the first power supply voltage Vcc1 drops before the second power supply voltage Vcc2, the reset request signal Sd from the logic unit 11 becomes Low so as to carry out the reset operation in an area where the second power supply voltage Vcc2 is still above the minimum operation guarantee level. No problem, therefore, occurs to the circuitry.

Hereinafter, examples of the internal configuration and the operation of the analog power supply monitor 20 will be described in detail.

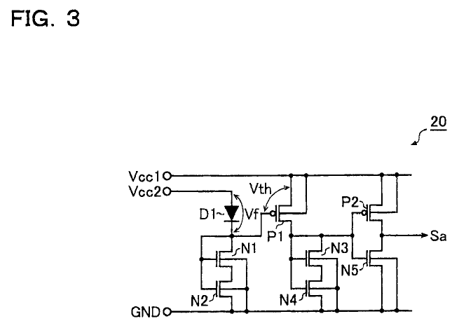

FIG. 3 is a block diagram showing a configuration example of the analog power supply monitor 20.

As shown in FIG. 3, the analog power supply monitor 20 of this example includes: a diode D1; P-channel type MOS field effect transistors P1 and P2; and N-channel type MOS field effect transistors N1 to N5.

An anode of the diode D1 is connected to an application terminal for the second power supply voltage Vcc2, a terminal to which the second power supply voltage Vcc2 is applied. A cathode of the diode D1 is connected to a drain of the transistor N1. A source of the transistor N1 is connected to a drain of the transistor N2. A source of the transistor N2 is connected to a ground terminal. Gates of the transistors N1 and N2 are connected to the cathode of the diode D1. Backgates of the transistors N1 and N2 are connected to the grounding terminal.

A source and a backgate of the transistor P1 are connected to an application terminal for the first power supply voltage Vcc1, a terminal to which the fist power supply voltage Vcc1 is applied. A gate of the transistor P1 is connected to the cathode of the diode D1. A drain of the transistor P1 is connected to a drain of the transistor N3. A source of the transistor N3 is connected to a drain of the transistor N4. A source of the transistor N4 is connected to the grounding terminal. Gates of the transistors N3 and N4 are connected to the drain of the transistor P1. Backgates of the transistors N3 and N4 are connected to the grounding terminal.

A source and a backgate of the transistor P2 are connected to the application terminal for the first power supply voltage Vcc1. A gate of the transistor P2 is connected to the drain of the transistor P1. A drain of the transistor P2 is connected to a drain of the transistor N5 while at the same time, as an output end for the monitor signal Sa, connected to an input end of the logical AND operator 21 (not shown in FIG. 3). A source and a backgate of the transistor N5 are connected to the grounding terminal. A gate of the transistor N5 is connected to the drain of the transistor P1.

In the analog power supply monitor 20 configured as described above, a voltage (Vcc2-Vf) lower than the second power supply voltage Vcc2 by a forward voltage drop Vf (approximately 0.6 V) of the diode D1 is applied to the gate of the transistor P1. While the liquid crystal display device is on, the second power supply voltage Vcc2 remains at 2.8 V, and hence the gate voltage of the transistor P1 remains at approximately 2.2 V. On the other hand, the first power supply voltage Vcc1 is applied to the source of the transistor P1. While the display device is on, the first voltage Vcc1 remains at 1.8 V, and hence the source voltage of the transistor P1 also remains at 1.8 V.

While the display device is on, the gate voltage is, therefore, higher than the source voltage of the transistor P1, the transistor P1 is off, and the drain voltage thereof is Low via the transistors N3 and N4. Consequently, the transistor P2 is on, and the transistor N5 is off. The monitor signal Sa is High, accordingly.

On the other hand, in the case where the power to the liquid crystal display device is turned off in a sequence different from the normal one, such as when the battery is removed from the liquid crystal display device in operation, the second power supply voltage Vcc2 drops and the gate voltage of the transistor P1 (Vcc2-Vf) becomes lower than the source voltage Vcc1 by an on-threshold voltage Vth of the transistor P1 (approximately 0.6 V). Thereby, the transistor P1 is turned on and the drain voltage of the transistor P1 becomes High along with the first voltage Vcc1. Accordingly, the transistor P2 is turned off, and the transistor N5 is turned on. The monitor signal Sa thus becomes Low.

It should be noted that in a configuration where the diode D1 is not employed and the second power supply voltage Vcc2 is directly applied to the gate of the transistor P1, the second power supply voltage Vcc2 may fall below the minimum operation guarantee level of the analog circuitry when the transistor P1 shifts from off to on. In order to ensure that the liquid crystal cells are surely discharged, the circuit configuration shown in FIG. 3 is, therefore, preferable.

As described above, with the analog power supply monitor 20 configured as described above, in a case where the second power supply voltage Vcc2 falls far below the actual usable range, and before the second power supply voltage Vcc2 falls below the minimum operation guarantee level of the analog circuitry, exploitation of the forward voltage drop Vf of the diode D1 makes it possible to shift the logic level of the monitor signal Sa from High to Low. The discharging of the liquid crystal cells can, therefore, be surely executed upon power-off of the liquid crystal display device without being affected by noise or the like.

The present invention has been described by way of example where it is applied to a liquid crystal display device for driving a liquid crystal panel of a simple matrix type. However, the present invention finds application not only in such devices but also in liquid crystal display devices for driving liquid crystal display panels of any other types and even in power supply devices incorporated in other kinds of devices in general.

The present invention can be carried out in any manner other than specifically described herein, and many variations and modifications are possible without departing from the scope of the invention.

For example, whereas in the above-described embodiment the logical AND operator 21 is employed as a logic gate unit for generating the logical AND operation signal between the monitor signal Sa and the external reset signal Sb, the configuration of the present invention is not limited thereto, and any other type of logic gate may also be employed. Alternatively, the monitor signal Sa may be directly inputted to the logic unit 11.

In terms of industrial applicability, the present invention is useful in preventing the display of unwanted lines upon power-off of the battery-operated liquid crystal driving devices.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A liquid crystal driving device comprising:
a power supply monitor for monitoring, using a first power supply voltage as a drive voltage, a second power supply voltage higher than the first power supply voltage so as to generate a monitor signal that indicates whether or not the second power supply voltage is below a predetermined threshold;
a logic unit for generating, using the first power supply voltage as a drive voltage, a reset request signal according to the monitor signal;
a reset signal generation unit for generating, using the second power supply voltage as a drive voltage, a reset signal according to the reset request signal; and
a driver unit for discharging, using the second power supply voltage as a drive voltage, liquid crystal cells according to the reset signal.

2. The power supply monitor of the liquid crystal driving device of claim 1, wherein
the power supply monitor comprises:
a diode having an anode thereof connected to an application terminal for the second power supply voltage; and
a P-channel field effect transistor having a source thereof connected to an application terminal for the first power supply voltage and a gate thereof connected to a cathode of the diode, and
the power supply monitor shifts a logic level of the monitor signal according to a drain voltage of the P-channel field effect transistor.

3. The liquid crystal driving device of claim 1 further comprising:
a logic gate unit for generating a logical operation signal between the monitor signal and an external reset signal, wherein
the logic unit generates the reset request signal according to the logical operation signal.

4. The liquid crystal driving device of claim 2 further comprising:
a logic gate unit for generating a logical operation signal between the monitor signal and an external reset signal, wherein
the logic unit generates the reset request signal according to the logical operation signal.

5. A liquid crystal display device comprising:
a liquid crystal display panel having liquid crystal cells interposed between a plurality of scanning lines and a plurality of signal lines; and
a liquid crystal driving device for controlling driving of the liquid crystal cells, wherein
the liquid crystal driving device comprises:
a power supply monitor for monitoring, using a first power supply voltage as a drive voltage, a second power supply voltage higher than the first power supply voltage so as to generate a monitor signal that indicates whether or not the second power supply voltage is below a predetermined threshold;
a logic unit for generating, using the first power supply voltage as a drive voltage, a reset request signal according to the monitor signal;
a reset signal generation unit for generating, using the second power supply voltage as a drive voltage, a reset signal according to the reset request signal; and
a driver unit for discharging, using the second power supply voltage as a drive voltage, the liquid crystal cells according to the reset signal.

6. The power supply monitor of the liquid crystal display device of claim 5 comprising:
a diode having an anode thereof connected to an application terminal for the second power supply voltage; and
a P-channel field effect transistor having a source thereof connected to an application terminal for the first power supply voltage and a gate thereof connected to a cathode of the diode, wherein
the power supply monitor shifts a logic level of the monitor signal according to a drain voltage of the P-channel field effect transistor.

7. The liquid crystal driving device of the liquid crystal display device of claim 5 further comprising a logic gate unit for generating a logical operation signal between the monitor signal and an exterior reset signal, wherein
the logic unit generates the reset request signal according to the logical operation signal.

8. The liquid crystal driving device of the liquid crystal display device of claim 6 further comprising a logic gate unit for generating a logical operation signal between the monitor signal and an external reset signal, wherein
The logic unit generates the reset request signal according to the logical operation signal.
